(19) United States
(12) Patent Application Publication
(10) Pub. No.: US 2017/0187258 A1
(43) Pub. Date: Jun. 29, 2017

(54) PERMANENT MAGNET, PERMANENT MAGNET MANUFACTURING METHOD, ROTATING ELECTRIC MACHINE, AND ROTATING ELECTRIC MACHINE MANUFACTURING METHOD

(71) Applicant: NITTO DENKO CORPORATION, Ibaraki-shi, Osaka (JP)

(72) Inventors: Kenichi FUJIKAWA, Ibaraki-shi, Osaka (JP); Katsuya KUME, Ibaraki-shi, Osaka (JP); Toshinobu HOSHINO, Ibaraki-shi, Osaka (JP); Miho YAMAGUCHI, Ibaraki-shi, Osaka (JP); Masakazu MORIMOTO, Ibaraki-shi, Osaka (JP); Makoto FUJIHARA, Ibaraki-shi, Osaka (JP); Toshiaki OKUNO, Ibaraki-shi, Osaka (JP); Eiichi IMOTO, Ibaraki-shi, Osaka (JP); Hirofumi EBE, Ibaraki-shi, Osaka (JP); Tomohiro OMURE, Ibaraki-shi, Osaka (JP); Izumi OZEKI, Ibaraki-shi, Osaka (JP); Yuki KATO, Ibaraki-shi, Osaka (JP); Takashi YAMAMOTO, Ibaraki-shi, Osaka (JP); Shoichiro SAITO, Ibaraki-shi, Osaka (JP)

(73) Assignee: NITTO DENKO CORPORATION, Ibaraki-shi, Osaka (JP)

(21) Appl. No.: 15/315,451

(22) PCT Filed: May 25, 2015
(86) PCT No.: PCT/JP2015/064888

§ 371 Date: Dec. 1, 2016

(30) Foreign Application Priority Data
Jun. 2, 2014 (JP) 2014-113964

(51) Int. Cl. H02K 1/27; H01F 7/02; H01F 41/02; H02K 15/03

(52) U.S. Cl. CPC H02K 1/2786; H02K 15/03; H01F 7/02; H01F 41/0266

(57) ABSTRACT

Raw material magnet is milled to magnet powder, and the magnet powder thus milled is mixed with a binder to form a compound 12. Then, the compound 12 thus formed is molded to a green sheet 14 having a sheet shape. Thereafter, a magnetic field orientation is carried out by applying a magnetic field to the green sheet 14 thus molded, and then, the green sheet 14 having been subjected to the magnetic field orientation is shaped to a product shape by deforming thereof. Thereafter, the permanent magnet 1 is produced by sintering thereof. The permanent magnet 1 has a ring shape, and is constituted such that an axis of easy magnetization may be orientated at a slant so as to converge in a direction along a converging axis P which is set to a radius direction as well as to a center direction of the ring shape.

### TECHNICAL FIELD

The present invention relates to a permanent magnet, a method for manufacturing a permanent magnet, a rotating electric machine, and a method for manufacturing a rotating electric machine.

### BACKGROUND ART

In recent years, in such fields as machine tools, vehicles, aircrafts, wind electric power motors, and the like, rotating electric machines such as an electric power generator that converts a mechanical energy transmitted from an engine or the like to an electric energy as well as a motor (electric motor) and the like that convert, on the contrary to the above, an electric energy to a mechanical energy are generally used. And also, further increases in a torque and an electric power generation are needed in the rotating electric machines.

As to a method for manufacturing a permanent magnet to be used in the rotating electric machines, a powder sintering method has been generally used. In this powder sintering method, first, a raw material is milled by a jet mill or the like (dry-milling method) to produce magnet powder. Thereafter, the resulting magnet powder is put in a mold and pressed to mold to a prescribed shape. Then, the magnet powder molded to the prescribed shape in a solid state is sintered at a prescribed temperature (for example, at 1100° C. for the case of Nd—Fe—B-based magnet) for completion (See, for example, Japanese Laid-Open Patent Application Publication No. 02-266503). In addition, in order to improve magnetic properties of a permanent magnet, magnetic field orientation is generally carried out by applying a magnetic field from outside. In the method for manufacturing a permanent magnet by a conventional powder sintering method, magnet powder is filled into a mold at the time of press molding; and then, a pressure is applied after a magnet field is applied thereto to carry out the magnetic field orientation so as to mold the magnet powder to a formed body of compressed powder. In other method for manufacturing a permanent magnet such as an extrusion molding method, an injection molding method, and a roll molding method, a magnet has been molded by applying a pressure under the atmosphere in which a magnetic field is applied. By so doing, a formed body having direction of the axis of easy magnetization (C-axis) of each magnet particle constituting the permanent magnet aligned in a direction of an applied magnetic field can be formed.

As to the method for aligning the axes of easy magnetization of an anisotropic magnet, an axial anisotropy, a radial anisotropy, a polar anisotropy, and the like may be mentioned. Also, when the anisotropic magnet is used in a rotating electric machine, what have been done is not to orient the axes of easy magnetization of each magnet particle to the same direction (namely, in parallel) but to orient the axes of easy magnetization toward a direction that a magnetic flux of magnetized anisotropic magnets concentrates with an aim to reduce a torque ripple or to enhance a driving force (for example, Japanese Patent Laid-Open Publication No. 2005-287181).

### PRIOR ART DOCUMENTS

### Patent Documents

Patent document 1: Japanese Laid-Open Patent Application Publication No. 02-266503 (page 5)
Patent document 2: Japanese Laid-Open Patent Application Publication No. 2005-287181 (page 5, FIG. 2)

### DISCLOSURE OF THE INVENTION

### Problems to be Solved by the Invention

With regard to the rotating electric machine, an inner rotor type wherein a permanent magnet is accommodated inside thereof as a rotor, and an iron core and a winding wire are disposed outside thereof as a stator is generally used. On the contrary to the inner rotor type, there also exists an outer rotor type wherein a stator including an iron core and a winding wire is disposed inside thereof, and a rotor including a permanent magnet is disposed outside thereof so as to rotate the outside; and this is employed in a motor and so forth for rotation of a disk of an HDD and of an optical disk because it is excellent in a constant rate. Besides, there also exists a type called a dual rotor, such as a magnetic decelerator and a motor for a washing machine, wherein as the rotors the permanent magnets are disposed both inside and outside the stator including an iron core and a winding wire (namely, there exist two rotors for one stator).

And, in both the outer rotor type rotating electric machine and the dual rotor type rotating electric machine, optimization of the orientation direction of the axis of easy magnetization of an anisotropic magnet to be disposed in the rotor has been wanted.

The present invention was made to solve the conventional problems as described above, and thus, an object of the present invention is to provide: a permanent magnet wherein in a permanent magnet having a ring shape that is disposed in an outer rotor type rotating electric machine, or in a dual rotor type rotating electric machine, or the like, a magnetic flux is concentrated to a side of a stator present inside thereof so as to enhance a maximum magnetic flux density thereby realizing increases in a torque and an electric power generation of the rotating electric machines; a method for manufacturing a permanent magnet; a rotating electric machine using the permanent magnet; and a method for manufacturing a rotating electric machine.

### Means for Solving the Problems

In order to achieve the above-mentioned object, the permanent magnet according to the present invention is characterized by that the permanent magnet has a ring shape, and an axis of easy magnetization is orientated at a slant so as to converge in a direction along a converging axis which is set to a radius direction as well as to a center direction of the ring shape.

In addition, the permanent magnet according to the present invention is characterized by that a shape of a magnetic flux density distribution along a circumferential direction of an inner circumference surface becomes a sine wave shape.

In addition, the permanent magnet according to the present invention is characterized by that the permanent magnet is manufactured by a method including: milling a magnet raw material into magnet powder; preparing a mixture of the magnet powder thus milled with a binder; molding the mixture to a formed body having a prescribed shape; carrying out a magnetic field orientation to the formed body; and sintering the magnetically orientated formed body by keeping at a sintering temperature.

In addition, the permanent magnet according to the present invention is characterized by that in the magnetic field orientation process, the magnetic field orientation to the formed body is carried out such that after applying a magnetic field to the mixture, a direction of an axis of easy magnetization is manipulated by deforming the mixture having been applied with the magnetic field to the formed body.

In addition, the permanent magnet according to the present invention is characterized by that in the magnetic field orientation process, after the mixture is molded to a sheet shape, a magnetic field is applied to the mixture in the sheet shape.

In addition, the permanent magnet according to the present invention is characterized by that the permanent magnet is disposed in a rotor of an outer rotor type rotating electric machine, and an axis of easy magnetization is orientated so as to be slanted to a rotation axis side along a circumferential direction of the rotor.

In addition, the permanent magnet according to the present invention is characterized by that in a case when the permanent magnet is disposed in the rotor of the rotating electric machine and magnetized, a magnetic flux inside the magnet is concentrated to a rotation axis direction from an outside direction of the rotor.

In addition, the rotating electric machine according to the present invention is characterized by that the rotating electric machine is an outer rotor type rotating electric machine having a permanent magnet disposed in a rotor, and the permanent magnet has a ring shape, and an axis of easy magnetization is orientated at a slant so as to converge in a direction along a converging axis which is set to a radius direction as well as to a center direction of the ring shape.

In addition, the method for manufacturing a permanent magnet according to the present invention is characterized by that the method is to manufacture a permanent magnet having a ring shape, and the method includes: milling a magnet raw material into magnet powder; preparing a mixture of the magnet powder thus milled with a binder; carrying out magnetic field orientation by applying a magnetic field to the mixture; and sintering the formed body of the magnetically orientated mixture by keeping at a sintering temperature; and in the magnetic field orientation process, an axis of easy magnetization is orientated at a slant so as to converge in a direction along a converging axis which is set to a radius direction as well as to a center direction of the ring shape.

In addition, the method for manufacturing a permanent magnet according to the present invention is characterized by that in the magnetic field orientation process, the magnetic field orientation is carried out such that a shape of a magnetic flux density distribution along a circumferential direction of an inner circumference surface of the manufactured permanent magnet may become a sine wave shape.

In addition, the method for manufacturing a permanent magnet according to the present invention is characterized by that in the magnetic field orientation process, the magnetic field orientation is carried out such that after applying a magnetic field to the mixture, a direction of the axis of easy magnetization is manipulated by deforming the mixture having been applied with a magnetic field to the formed body.

In addition, the method for manufacturing a permanent magnet according to the present invention is characterized by that in the magnetic field orientation process, after the mixture is molded to a sheet shape, a magnetic field is applied to the mixture in the sheet shape.

In addition, the method for manufacturing a permanent magnet according to the present invention is characterized by that the permanent magnet is disposed in a rotor of an outer rotor type rotating electric machine, and an axis of easy magnetization is orientated so as to be slanted to a rotation axis side along a circumferential direction of the rotor.

In addition, the method for manufacturing a permanent magnet according to the present invention is characterized by that in a case when the permanent magnet is disposed in the rotor of the rotating electric machine and magnetized, a magnetic flux inside the magnet is concentrated to a rotation axis direction from an outside direction of the rotor.

Further, the method for manufacturing a rotating electric machine according to the present invention is characterized by that the method is to manufacture an outer rotor type rotating electric machine which is manufactured by disposing a permanent magnet in a rotor; and the permanent magnet has a ring shape and is manufactured by a method including: milling a magnet raw material into magnet powder; preparing a mixture of the magnet powder thus milled with a binder; carrying out magnetic field orientation to the mixture by applying a magnetic field; and sintering the formed body of the magnetically orientated mixture by keeping at a sintering temperature; and in the magnetic field orientation process, an axis of easy magnetization is orientated at a slant so as to converge in a direction along a converging axis which is set to a radius direction as well as to a center direction of the ring shape.

### Effect of the Invention

According to the permanent magnet of the present invention with the embodiments described above, because the axis of easy magnetization is orientated at a slant so as to converge in a direction along a converging axis which is set to a radius direction as well as to a center direction of the ring shape, a magnetic flux can be properly concentrated after magnetization; and thus, not only a maximum magnetic flux density can be increased but also a variance in the magnetic flux density can be avoided. Especially, in a rotating electric machine wherein a rotor is disposed outside a stator of an outer rotor type rotating electric machine, a dual rotor type rotating electric machine, or the like, if a permanent magnet is disposed in the rotor present outside thereof, the maximum magnetic flux density can be increased by concentrating the magnetic flux to the side of the stator present inside thereof, so that not only a torque and an electric power generation can be increased but also a torque ripple can be reduced.

In addition, according to the permanent magnet according to the present invention, a wave shape of the magnetic flux density distribution along a circumferential direction of an inner circumference surface of the permanent magnet can approximate an ideal sine wave shape. As a result, a torque ripple can be reduced, and in addition, a driving control of a rotating electric machine can be carried out accurately if the permanent magnet is disposed in the rotating electric machine.

In addition, according to the permanent magnet of the present invention, by constituting so as to mold a mixture of magnet powder mixed with a binder, the orientation can be made such that the axes of easy magnetization may properly converge to one direction along a converging axis. As a result, the magnetic flux can be properly concentrated after magnetization, so that not only the maximum magnetic flux density can be increased but also a variance in the magnetic flux density can be avoided.

In addition, because the mixture with a binder is molded, the magnet particles do not rotationally move after orientation as compared with the case of using a powder compaction molding method or the like, so that the degree of orientation can be improved as well.

In addition, when the magnetic field orientation is carried out to the mixture with a binder, the number of current turns can be utilized, so that a high magnetic field strength can be secured during the time of the magnetic field orientation process; and in addition, because a magnetic field can be applied in a static magnetic field for a long period of time, a high degree of orientation with a low variation thereof can be realized. Further, if the orientation direction is corrected after orientation, an orientation with a high degree of orientation and a low variation can be secured.

In addition, realization of a high orientation with a low variation can contribute to reduction in the contraction variation due to sintering. That is, uniformity of the product shape after sintering can be secured. As a result, a burden of an outer shape processing after sintering can be lowered, so that a significant improvement of stability in mass production can be expected.

In addition, according to the permanent magnet according to the present invention, by deforming the mixture having been once subjected to the magnetic field orientation, the orientation direction can be corrected, so that the orientation can be made such that the axes of easy magnetization may properly converge to one direction along the converging axis. As a result, the orientation with a high degree of orientation and a low variation can be made. In addition, with deforming the mixture to the formed body, the orientation direction can be corrected simultaneously with the deformation. As a result, formation of the permanent magnet and orientation can be carried out in one process, so that the productivity can be improved.

In addition, according to the permanent magnet according to the present invention, the magnetic field orientation is carried out after the mixture is once molded to the sheet shape, which is then followed by deformation to the formed body; and thus, the molding process and the magnetic field orientation process can be carried out efficiently in a continuous process, so that the productivity can be improved.

In addition, according to the permanent magnet according to the present invention, because the axis of easy magnetization is slanted to a rotation axis side along a circumferential direction of the rotor of the outer rotor type rotating electric machine, in the case when the permanent magnet is disposed in an inside surface of the rotor and magnetized, the magnetic flux can be concentrated more to a rotation axis direction from an outside direction of the rotor. As a result, a torque and an electric power generation of the rotating electric machine in which the permanent magnet is disposed can be increased.

In addition, according to the permanent magnet according to the present invention, in the case when the permanent magnet is disposed in an inside surface of the rotor of the outer rotor type rotating electric machine, a torque and an electric power generation of the rotating electric machine in which the permanent magnet is disposed can be increased.

In addition, according to the rotating electric machine of the present invention, increase in power generation of an electric power generator, as well as increase in torque and efficiency of a motor with decrease in size and torque ripple more than ever can be realized in the outer rotor type rotating electric machine.

In addition, according to the method for manufacturing a permanent magnet of the present invention, because in the permanent magnet thus manufactured the axis of easy magnetization is orientated at a slant so as to converge in a direction along a converging axis which is set to a radius direction as well as to a center direction of the ring shape thereof, the magnetic flux can be properly concentrated after magnetization; and thus, not only a maximum magnetic flux density can be increased but also a variance in the magnetic flux density can be avoided. Especially, in a rotating electric machine wherein a rotor is disposed outside a stator of an outer rotor type rotating electric machine, a dual rotor type rotating electric machine, or the like, if the permanent magnet is disposed in the rotor present outside thereof, the maximum magnetic flux density can be increased by concentrating the magnetic flux to the side of the stator present inside thereof, so that not only a torque and an electric power generation of the rotating electric machine disposed with the permanent magnet can be increased but also a torque ripple thereof can be reduced.

In addition, by constituting so as to mold a mixture of magnet powder mixed with a binder, the orientation can be made such that the axes of easy magnetization may properly converge to one direction along a converging axis. As a result, the magnetic flux can be properly concentrated after magnetization, so that not only the maximum magnetic flux density can be increased but also a variance in the magnetic flux density can be avoided.

In addition, because the mixture with a binder is molded, the magnet particles do not move rotationally after orientation as compared with the case of using a powder compaction molding method or the like, so that the degree of orientation can be improved as well.

In addition, when the magnetic field orientation is carried out to the mixture with a binder, the number of current turns can be utilized, so that a high magnetic field strength can be secured during the time of the magnetic field orientation process; and in addition, because a magnetic field can be applied in a static magnetic field for a long period of time, a high degree of orientation with a low variation thereof can be realized. Further, after orientation, if the orientation direction is corrected, an orientation with a high degree of orientation and a low variation can be secured.

In addition, realization of a high orientation with a low variation can contribute to reduction in the contraction variation due to sintering. That is, uniformity of the product shape after sintering can be secured. As a result, a burden of an outer shape processing after sintering can be lowered, so that a significant improvement of stability in mass production can be expected.

In addition, according to the method for manufacturing a permanent magnet of the present invention, a wave shape of the magnetic flux density distribution along a circumferential direction of an inner circumference surface of the permanent magnet can approximate an ideal sine wave shape.

As a result, a torque ripple can be reduced, and in addition, a driving control of a rotating electric machine can be carried out accurately if the permanent magnet is disposed in the rotating electric machine.

In addition, according to the method for manufacturing a permanent magnet of the present invention, by deforming the mixture having been once subjected to the magnetic field orientation, the orientation direction can be corrected, so that the orientation can be made such that the axes of easy magnetization may properly converge to one direction along the converging axis. As a result, the orientation with a high degree of orientation with a low variation thereof can be made. In addition, with deforming the mixture to the formed body, the orientation direction can be corrected simultaneously with the deformation. As a result, formation of the permanent magnet and orientation can be carried out in one process, so that the productivity can be improved.

In addition, according to the method for manufacturing a permanent magnet of the present invention, because the magnetic field orientation is carried out after the mixture is once molded to the sheet shape, which is then followed by deformation to the formed body, the molding process and the magnetic field orientation process can be carried out in a continuous process, so that the productivity can be improved.

In addition, according to the method for manufacturing a permanent magnet of the present invention, because the axis of easy magnetization is slanted to a rotation axis side along a circumferential direction of the rotor of the outer rotor type rotating electric machine, in the case when the permanent magnet is disposed in an inside surface of the rotor and magnetized, the magnetic flux can be concentrated more to a rotation axis direction from an outside direction of the rotor. As a result, a torque and an electric power generation of the rotating electric machine in which the permanent magnet is disposed can be increased.

In addition, according to the method for manufacturing a permanent magnet of the present invention, in the case that the permanent magnet thus manufactured is disposed in an inside surface of the rotor of the outer rotor type rotating electric machine, a torque and an electric power generation of the rotating electric machine in which the permanent magnet is disposed can be increased.

In addition, according to the method for manufacturing a rotating electric machine of the present invention, increase in power generation of an electric power generator, increase in torque and efficiency of a motor with decrease in size and torque ripple thereof more than ever can be realized in the outer rotor type rotating electric machine.

### BRIEF DESCRIPTION OF THE DRAWINGS

FIG. 1 is an overall view of a permanent magnet according to the present invention.

FIG. 2 is a diagram illustrating an outer rotor type rotating electric machine in which the permanent magnet is disposed.

FIG. 3 is a diagram illustrating a direction of the axis of easy magnetization of the permanent magnet.

FIG. 4 is a diagram illustrating a direction of the axis of easy magnetization of the permanent magnet.

FIG. 5 is a diagram illustrating a polar anisotropic orientation which is an inward direction formed by the permanent magnet having a ring shape.

FIG. 6 is an explanatory diagram illustrating the method for manufacturing a permanent magnet according to the present invention.

FIG. 7 is an explanatory diagram illustrating especially the molding process of a green sheet and the magnetic field orientation process thereof in the manufacturing process of a permanent magnet according to the present invention.

FIG. 8 is a diagram illustrating the permanent magnet formed by laminating the green sheets and a direction of the axis of easy magnetization.

FIG. 9 is an explanatory diagram illustrating especially the temperature rising embodiment in the calcination process in the manufacturing process of a permanent magnet according to the present invention.

FIG. 10 is an explanatory diagram illustrating a manufacturing process of the rotating electric machine of the present invention.

### BEST MODE FOR CARRYING OUT THE INVENTION

Specific one embodiment of the permanent magnet and the method for manufacturing the permanent magnet as well as the rotating electric machine using the permanent magnet and the method for manufacturing the rotating electric machine according to the present invention will be described below in detail with reference to the drawings.

[Embodiment of Permanent Magnet]

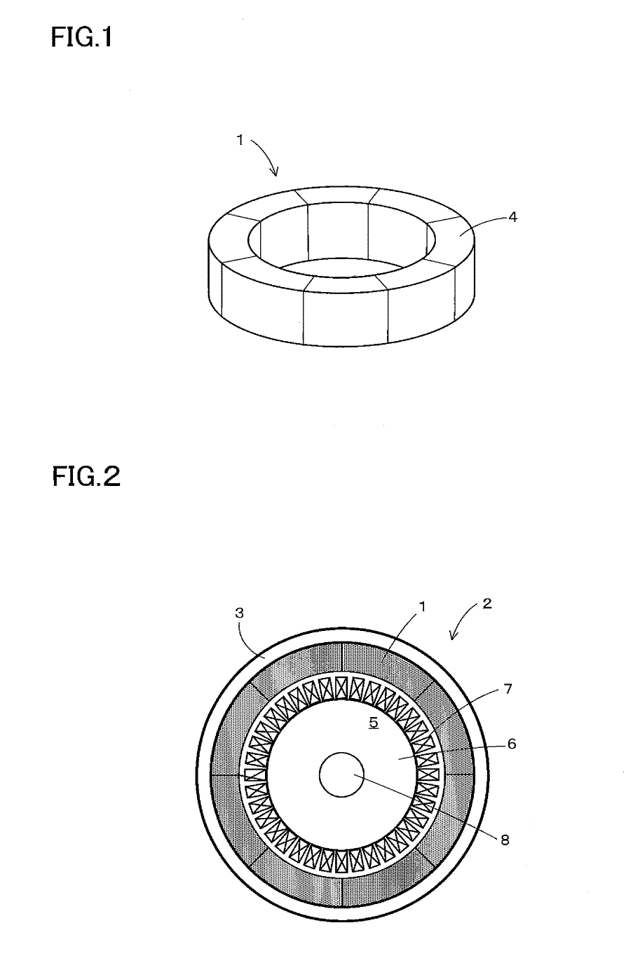

First, an embodiment of the permanent magnet 1 according to the present invention will be explained. FIG. 1 is an overall view of the permanent magnet 1 according to the present invention. Meanwhile, as depicted in FIG. 1, the permanent magnet 1 according to the present invention is an anisotropic ring magnet having an annular ring shape. And, as depicted in FIG. 2, the permanent magnet is disposed in an inside surface of the rotor 3 of the outer rotor type rotating electric machine 2 (motor or electric power generator) so as to constitute the outer rotor type rotating electric machine 2. FIG. 2 is a drawing illustrating the outer rotor type rotating electric machine 2 in which the permanent magnet 1 is disposed. Meanwhile, in the below examples, explanation will be made with regard to an example in which the permanent magnet 1 is the anisotropic ring magnet; however, a shape (for example, size of the diameter), a number of poles, and the like of the permanent magnet 1 can be arbitrarily changed in accordance with a shaping embodiment and an orientation embodiment of the permanent magnet, as discussed later. For example, the shape thereof may be a fan-like shape, a ring-like shape, a bow-like shape, or a rectangular shape.

Further, the permanent magnet 1 according to the present invention is made of an Nd—Fe—B-based magnet. Meanwhile, the contents of respective components are regarded to be 27 to 40% by weight for Nd, 0.8 to 2% by weight for B, and 60 to 70% by weight for Fe (electrolytic iron). Furthermore, the permanent magnet 1 may contain other elements such as Dy, Tb, Co, Cu, Al, Si, Ga, Nb, V, Pr, Mo, Zr, Ta, Ti, W, Ag, Bi, Zn or Mg in small quantities so as to improve the magnetic properties thereof.

In addition, as depicted in FIG. 1, after a plurality of sintered members 4 having a fan-like shape (segment type) are fabricated into an annular ring shape, they are bonded with each other by an adhesive including a resin or the like (for example, a mixture of a resin and a solvent), which is followed by magnetization so as to constitute the permanent magnet 1. Meanwhile, bonding of the sintered members 4 may be made by a plasticizer or a hot-press adhesion, in addition to the adhesive. In addition, number of the sintered member 4 corresponds to the number of the poles of the permanent magnet 1; and therefore, for example, in the case that the number of the poles of the permanent magnet 1 is regarded to be 8, the permanent magnet 1 is composed of eight sintered members 4, as depicted in FIG. 1.

Further, each sintered member 4 which constitutes the permanent magnet 1 is formed, as described later, by sintering a formed body (green body) formed by molding the mixture of magnet powder mixed with a binder. Meanwhile, an embodiment may also be allowed wherein the mixture is not molded directly to the segment type shape as depicted in FIG. 1, but once the mixture is molded to a shape other than the segment type shape (for example, a sheet shape, a block shape, and the like), which is then followed by a punching process, a cutting process, a deforming process, or the like to the segment type shape. In addition, especially when the embodiment wherein the mixture is once molded to a sheet shape followed by processing to the segment type shape is employed, the production can be carried out with a continuous process, so that not only the productivity can be improved but also an accuracy of molding can be enhanced. When the mixture is molded to a sheet shape, the mixture is processed to a sheet member having a shape of a thin film with the thickness of, for example, in the range of 0.05 to 10 mm (for example 1 mm). Meanwhile, even if the sheet shape is chosen, by laminating a plurality of the sheets, the permanent magnet 1 having a large size can be produced as well.

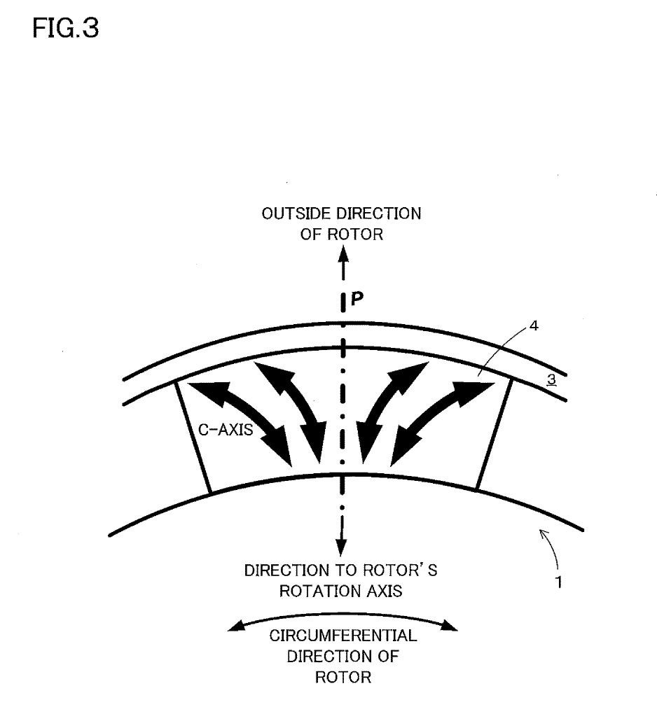

In addition, the permanent magnet 1 according to the present invention is an anisotropic magnet wherein each of the sintered members 4 which constitute the permanent magnet 1 is orientated, as depicted in FIG. 3, such that the axes of easy magnetization (C-axis) may converge to one direction (in FIG. 3, to a concave direction) along the converging axis P which passes through the magnet surface. As a result, orientation of the permanent magnet 1 in which the sintered members 4 are fabricated in the ring shape has an inward polar anisotropy as described later.

Meanwhile, in the example illustrated in FIG. 3, the converging axis P is set so as to pass through near a central part of the sintered member 4; however, the converging axis P may be set not near a central part but rather in a right side or a left side thereof. In addition, when the permanent magnet 1 is disposed in the rotor 3, as depicted in FIG. 3, the orientation is made such that the axis of easy magnetization (C axis) may be slanted from both ends of the sintered member 4 to a center side thereof, to a radius direction as well as a rotation axis direction (namely to an air gap side) along the circumferential direction of the rotor 3. More specifically, the axis of easy magnetization is formed along an exponential curve. As a result, when the permanent magnet 1 is disposed in the rotor 3 and magnetized, the magnetic flux inside the magnet is concentrated to the rotation axis direction from the outside direction (namely to an air gap side) along the radius direction of the rotor 3 (namely, the magnetic flux density of the inside surface of the magnet becomes higher).

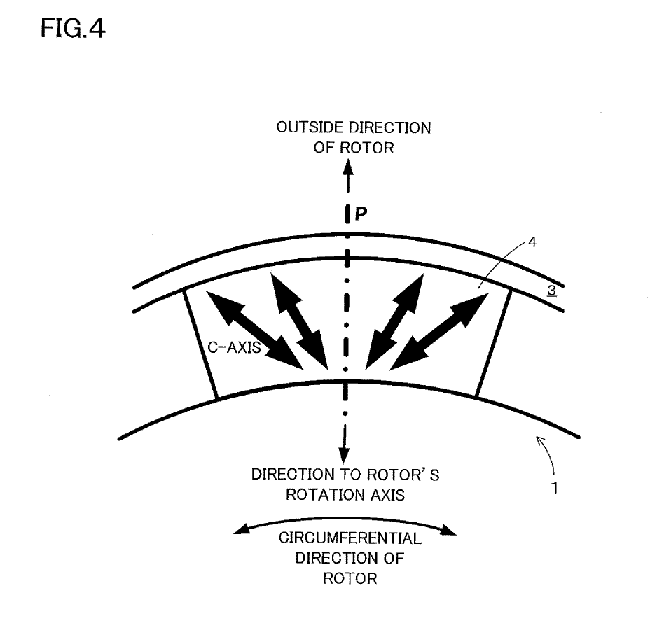

In addition, as depicted in FIG. 4, the orientation may be made such that the axes of easy magnetization converge linearly to one direction along the converging axis P. In such a case, too, the orientation of the permanent magnet 1 which is fabricated from the sintered members 4 has an inward polar anisotropy.

In addition, in the permanent magnet 1 according to the present invention, because the orientation is made by applying a magnetic field to the mixture of magnetic powder mixed with a binder as described later, magnet particle does not move rotationally by the pressure that is applied after the orientation as in the case of a powder compaction molding method; and thus, the degree of orientation can be enhanced. In addition, because there is no variance in the density distribution of the magnet powder as in the case of a PLP method, a near net shaping property can be enhanced. Further, if after the orientation is once made by applying a magnetic field to the mixture before shaping to a product shape (for example, the segment type as depicted in FIG. 1), the mixture is shaped (for example, deforming process) to the product shape with taking the direction of the axis of easy magnetization of the mixture into account, and the direction of the axis of easy magnetization can be manipulated during the shaping process to the product shape. Namely, the axes of easy magnetization can be properly orientated to the direction intended by a manufacturer. As a result, a permanent magnet whose axes of easy magnetization are orientated to a complicated direction (for example, the anisotropic ring magnet in which the axes of easy magnetization are orientated so as to converge to a certain direction, such as, for example, the one depicted in FIG. 3) can be realized readily and accurately.

Meanwhile, in the magnetic field orientation to the permanent magnet 1, an embodiment may also be allowed wherein after the orientation is once made by applying a magnetic field to the mixture before shaping to a product shape (for example, the segment type as depicted in FIG. 1), the mixture is shaped to the product shape, or alternatively, the orientation is made by applying a magnetic field after shaping to the product shape.

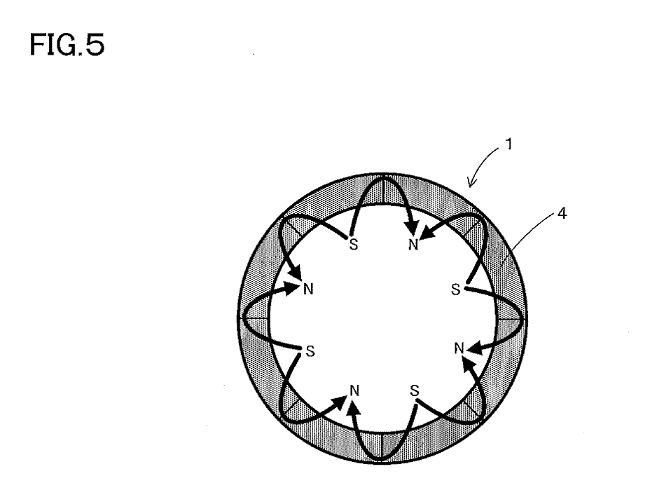

In addition, especially in the permanent magnet 1 wherein the sintered members 4 whose axes of easy magnetization are orientated as depicted in FIG. 3 and FIG. 4 are bonded in the annular ring shape, an inward polar anisotropic orientation as depicted in FIG. 5 can be realized. With this, in the magnetic flux density distribution along a circumferential direction of an inner circumference surface, the magnetic flux density distribution having a wave shape like a sine wave shape can be obtained. In addition, in the outer rotor type rotating electric machine provided with the permanent magnet having the inward polar anisotropic orientation, there are merits that a torque and a power generation of the rotating electric machine can be increased, and further, the torque ripple can be suppressed so that a driving control of the rotating electric machine can be performed accurately. In addition, by approximating the wave shape of the magnetic flux density distribution along a circumferential direction of the inner circumference surface of the permanent magnet 1 (namely, the magnetic flux density distribution along the air gap of the rotating electric machine) to an ideal sine wave shape, the torque ripple can be further reduced, so that the rotating electric machine having vibration and noisy sound reduced can be realized.

Also, in the present invention, in the case especially when the permanent magnet 1 is manufactured, illustrative example of the binder to be mixed with the magnet powder includes a resin, a long-chain hydrocarbon, a fatty acid ester, and a mixture of them.

Further, in the case that a resin is used for the binder, the resin to be used is preferably a polymer having no oxygen atom in its structure and being capable of depolymerization. In addition, as described later, in order to reuse a residual matter of the mixture of magnetic powder with a binder which is generated at the time of shaping the mixture to a prescribed shape (for example, a segment type), and also in order to carry out the magnetic field orientation of the mixture in a softened state by heating, a thermoplastic resin is used. Specifically, the resin belonging to this is a polymer or a copolymer of one or two or more kinds of monomers selected from monomers represented by the following general formula (1), provided that R1 and R2 each in the formula represent a hydrogen atom, a lower alkyl group, a phenyl group, or a vinyl group.

### [Chem. 1]

Illustrative example of the polymer satisfying the above condition include polyisobutylene (PIB; polymer of isobutylene), polyisoprene (isoprene rubber or IR; polymer of isoprene), polybutadiene (butadiene rubber or BR; polymer of 1,3-butadiene), polystyrene (polymer of styrene), styrene-isoprene block copolymer (SIS; copolymer of styrene and isoprene), butyl rubber (IIR; copolymer of isobutylene and isoprene), styrene-butadiene block copolymer (SBS; copolymer of styrene and butadiene), poly(2-methyl-1-pentene) (polymer of 2-methyl-1-pentene), poly(2-methyl-1-butene) (polymer of 2-methyl-1-butene), and poly(α-methylstyrene) (polymer of α-methylstyrene). Meanwhile, a low molecular weight polyisobutylene is preferably added to the poly(α-methylstyrene) to render flexibility thereto. Also, an embodiment may also be allowed that the resin to be used for the binder contains small quantities of a polymer or a copolymer of an oxygen-containing monomer (such as poly(butyl methacrylate) and poly(methyl methacrylate)). Further, a monomer not satisfying the above general formula (1) may be partially copolymerized thereto. Even in such a case, the purpose of the present invention can be realized.

Meanwhile, in order to suitably carry out the magnetic field orientation, the binder is preferably made of a thermoplastic resin that softens at 250° C. or lower, or more specifically, a thermoplastic resin whose glass transition point or flow initiation temperature is 250° C. or lower.

On the other hand, in the case that a long-chain hydrocarbon is used for the binder, a long-chain saturated hydrocarbon (long-chain alkane), which is a solid at room temperature and a liquid at a temperature higher than room temperature, is preferably used. Specifically, a long-chain saturated hydrocarbon having 18 or more carbon atoms is preferably used. At the time when the mixture of magnet powder with a binder is subjected to the magnetic field orientation as mentioned later, the magnetic field orientation is carried out under a state where the mixture is softened by heating at a temperature equal to or higher than the glass transition point or the flow initiation temperature of the long-chain hydrocarbon.

Likewise, in the case that a fatty acid ester is used for the binder, methyl stearate, methyl docosanoate, or the like, these being a solid at room temperature and a liquid at a temperature higher than room temperature, is preferably used. At the time when the magnetic field orientation is applied to the mixture of magnet powder with a binder as mentioned later, the magnetic field orientation is carried out under a state where the mixture is softened by heating at a temperature equal to or higher than the flow initiation temperature of the fatty acid ester.

By using a binder that satisfies the above condition as the binder to be mixed with the magnet powder, the carbon content and oxygen content in the magnet can be reduced. Specifically, the carbon content remaining in the magnet after sintering is made 2000 ppm or less, while more preferably 1000 ppm or less. Also, the oxygen content remaining in the magnet after sintering is made 5000 ppm or less, while more preferably 2000 ppm or less.

Further, the amount of the binder to be added may be an appropriate amount to fill the spaces among magnet particles so as to improve the thickness accuracy of the formed body at the time when the slurry or the compound molten by heating is molded. For example, the ratio of the binder to the total amount of the magnet powder and the binder is preferably in the range of 1 to 40% by weight, more preferably in the range of 2 to 30% by weight, while still more preferably in the range of 3 to 20% by weight.

[Embodiment of the Rotating Electric Machine]

The outer rotor type rotating electric machine 2 in which the permanent magnet 1 mentioned above is disposed in an inner circumference surface of the rotor 3 is constituted basically by a stator 5 and the rotor 3 which is disposed such that it rotates freely and encloses the stator 5 from the outside, as depicted in FIG. 2.

The stator 5 is constituted basically by the stator core 6, which is made of a magnetic material such as an electromagnetic steel sheet, and a plurality of the winding wires 7 which are wound to the stator core 6. Further, the stator core 6 includes a yoke having an annular ring shape and a plurality of the teeth which are protruded from the yoke to an outside radius direction, wherein the winding wire 7 is wound to the teeth. Meanwhile, with regard to the winding form of the winding wire 7, there are a concentrated winding method and a distributed winding method. The concentrated winding method is the form wherein the winding wire 7 is wound for each tooth; and the distributed winding method is the form wherein the winding wire 7 is wound over a plurality of the teeth.

The center of the stator 5 is provided with a rotation axis 8 which is supported to the stator 5 such that it can rotate freely. The rotation axis 8 is connected to the rotor 3 and is constituted such that it can rotate with rotation of the rotor 3 when the rotor 3 rotates.

On the other hand, in the inside surface of the rotor 3, as described before, the permanent magnet 1 having a ring shape is disposed. Then, the permanent magnet 1 is magnetized such that an S pole and an N pole may be alternately disposed, and also such that the permanent magnet may face to the stator 5 with a prescribed gap. Further, as depicted in FIG. 5, the embodiment is made such that the magnetic flux inside the magnet may be concentrated to a direction of the rotation axis 8 from an outside direction along the circumferential direction of the rotor 3.

In the embodiment as described above, when an electric current is applied to the winding wire 7 of the stator 5, an attraction force and a repulsion force are generated by magnetism between the rotor 3 and the stator 5 thereby rotating the rotor 3 with the rotation axis 8 as the center. Especially, in the present invention, by constituting such that the magnetic flux inside the magnet may be concentrated to a direction of the rotation axis 8 from an outside direction along the circumferential direction of the rotor 3, a high torque can be obtained.

[Method for Manufacturing the Permanent Magnet]

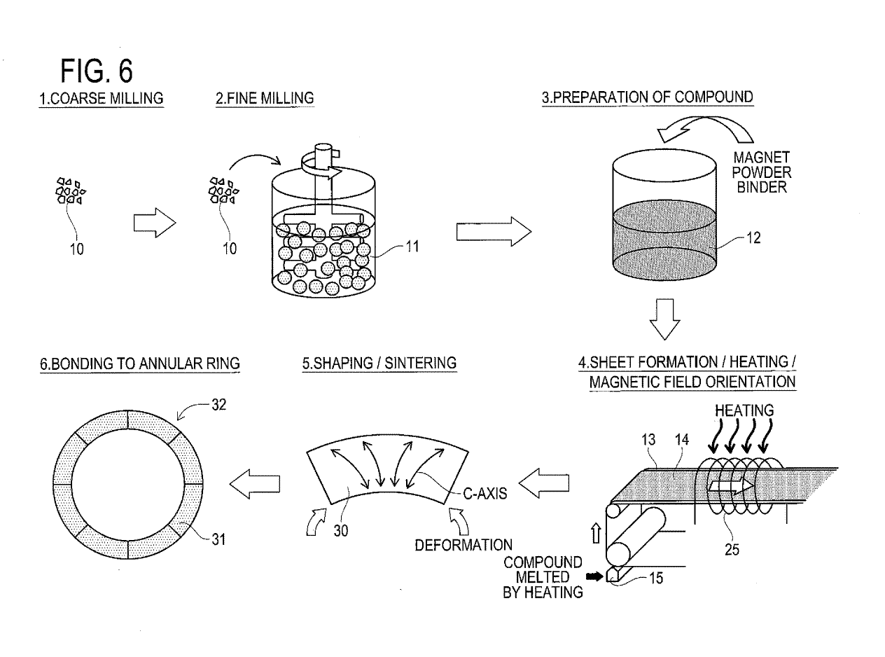

Next, the method for manufacturing the permanent magnet 1 according to the present invention will be explained below with reference to FIG. 6. FIG. 6 is an explanatory drawing illustrating the manufacturing process of the permanent magnet 1 according to the present invention.

First, an ingot including Nd—Fe—B with a prescribed fraction (for example, Nd: 32.7% by weight, Fe (electrolytic iron): 65.96% by weight, and B: 1.34% by weight) is prepared. Thereafter, the ingot is coarsely milled by using a stamp mill, a crusher, or the like to a size of about 200 μm. Alternatively, the ingot is melted, formed into flakes by using a strip-casting method, and then coarsely milled by using a hydrogen pulverization method. By so doing, coarsely milled magnet powder 10 can be obtained.

Next, the coarsely milled magnet powder 10 is finely milled by a wet method using a bead mill 11, or a dry method using a jet mill, or the like. For example, in fine milling using a wet method with the bead mill 11, the coarsely milled magnet powder 10 is finely milled to a particle size of within a prescribed range (for example, in the range of 0.1 to 5.0 μm) in a solvent whereby dispersing the magnet powder into the solvent. Thereafter, the magnet powder contained in the solvent after the wet milling is dried by such a method as vacuum drying to obtain the dried magnet powder. The solvent to be used in the milling is not particularly restricted, wherein illustrative example of the solvent that can be used includes alcohols such as isopropyl alcohol, ethanol, and methanol; esters such as ethyl acetate; lower hydrocarbons such as pentane and hexane; aromatics such as benzene, toluene, and xylene; ketones; and a mixture thereof. Meanwhile, it is preferable to use a solvent not containing an oxygen atom therein.

On the other hand, in fine milling using the dry method with a jet mill, the coarsely milled magnet powder is finely milled with the jet mill in: (a) an atmosphere including an inert gas such as a nitrogen gas, an argon (Ar) gas, a helium (He) gas, or the like, wherein an oxygen content therein is substantially 0%; or (b) an atmosphere including an inert gas such as a nitrogen gas, an Ar gas, a He gas, or the like, wherein an oxygen content therein is in the range of 0.0001 to 0.5%, to form fine powder whose average particle diameter is within a prescribed range (for example, in the range of 0.7 to 5.0 μm). Meanwhile, the term “an oxygen content therein is substantially 0%” is not limited to a case where the oxygen content is completely 0%, but may include a case where oxygen is contained in such an amount as to allow formation of an oxide film only faintly on the surface of the fine powder.

Next, the magnet powder finely milled by the bead mill 11 or the like is molded to a desired shape. Meanwhile, molding of the magnet powder is carried out by molding the mixture of the magnet powder mixed with the binder. In the examples illustrated below, the magnetic field orientation is carried out by applying a magnetic field to the mixture under the state thereof being once molded to a shape other than a product shape, and then, the product shape (for example, the segment type depicted in FIG. 1) is obtained by a punching process, a cutting process, a deforming process, or the like. Especially in the examples illustrated below, the mixture is once molded to a green formed body having a sheet shape (hereinafter, this is referred to as a green sheet), and then, it is shaped to the product shape. In the case that the mixture is molded especially to the sheet shape, there may be molding methods for it such as: a hot-melt coating method in which a compound, i.e., a mixture of the magnet powder with the binder, is heated and then followed by molding the compound to a sheet shape; a slurry coating method in which a slurry containing the magnet powder, the binder, and an organic solvent is applied onto a substrate thereby molding to a sheet shape; and the like.

Hereinafter, especially the green sheet molding using the hot-melt coating method will be especially explained.

First, a binder is mixed with the magnet powder which is finely milled by the bead mill 11 or the like thereby obtaining a clay-like mixture (compound) 12 including the magnet powder and the binder. Here, as mentioned before, a resin, a long-chain hydrocarbon, a fatty acid ester, a mixture thereof, or the like is used as the binder. For example, in the case that a resin is used, it is preferable to use a thermoplastic resin including a polymer which is capable of depolymerization and is a polymer of monomers not having an oxygen atom in its structure; and in the case that a long-chain hydrocarbon is used, and it is preferable to use a long-chain saturated hydrocarbon (long-chain alkane) which is a solid at room temperature and a liquid at a temperature higher than room temperature. In the case that a fatty acid ester is used, methyl stearate, methyl docosanoate, or the like is preferably used. Here, the amount of the binder to be added is preferably such that the ratio of the binder to the total amount of the magnet powder and the binder in the compound 12 after the addition as mentioned before may be in the range of 1 to 40% by weight, more preferably in the range of 2 to 30% by weight, while still more preferably in the range of 3 to 20% by weight.

In addition, in order to improve the degree of orientation in the later process of the magnetic field orientation, an additive to facilitate the orientation may be added to the compound 12. An illustrative example of the additive to facilitate the orientation is a hydrocarbon-based additive, wherein the use of a polar additive (specifically the acid dissociation constant pKa of less than 41) is especially preferable. Addition amount of the additive is dependent on the particle diameter of the magnet powder, wherein more amounts thereof are needed with smaller particle diameter of the magnet powder. Specifically, the addition amount thereof relative to the magnet powder is preferably in the range of 0.1 to 10 parts by mass, while more preferably in the range of 1 to 8 parts by mass. The additive that is added to the magnet powder attaches to a surface of the magnet particle, whereby playing a role to facilitate a rotation movement of the magnet particle in the later-mentioned magnetic field orientation process. As a result, the orientation takes place easily at the time when the magnetic field is applied, so that the axis of easy magnetization of each magnet particle can be aligned in the same direction (namely, a higher degree of orientation can be obtained). Especially in the case that the binder is added to the magnet powder, because the binder is present on the particle surface, a friction force during the orientation becomes larger thereby leading to decrease in orientation of the particles; and therefore, the effect of adding the additive is enhanced furthermore.

Meanwhile, addition of the binder is carried out under an atmosphere including an inert gas such as a nitrogen gas, an Ar gas, and a He gas. Meanwhile, mixing of the magnet powder with the binder is carried out, for example, by adding the magnet powder and the binder each into a stirring equipment whereby stirring them with a stirrer. Alternatively, in order to facilitate kneading, the stirring may be carried out with heating. Further, it is preferable to carry out the mixing of the magnet powder with the binder under an atmosphere including an inert gas such as a nitrogen gas, an Ar gas, and a He gas. Especially in the case that the magnet powder is obtained by milling with a wet method, an embodiment may be allowed that without taking out the magnet powder from a solvent used in the milling, the binder is added to the solvent, which is followed by kneading the resulting mixture and then evaporating the solvent from it, thereby the compound 12 to be mentioned later is obtained.

Next, a green sheet is prepared by molding the compound 12 to a sheet shape. Especially in the hot-melt coating method, the compound 12 is melted by heating the compound 12 to make it a fluid state, which is then followed by coating onto a supporting substrate 13 such as a separator. Thereafter, it is cooled for solidification to form a green sheet 14 having the shape of a long sheet on the supporting substrate 13. Meanwhile, although the temperature of heating the compound 12 for melting is different dependent on the kind and amount of the binder to be used, the temperature is made in the range of 50 to 300° C. However, the temperature needs to be made higher than a flow initiating temperature of the binder to be used. Meanwhile, in the case that the slurry coating method is used, the magnet powder and the binder (in addition, the additive to facilitate the orientation may also be included therein) are dispersed into a large amount of a solvent, and then the resulting slurry is coated onto the supporting substrate 13 such as a separator. Thereafter, the solvent is evaporated by drying, resulting in formation of the green sheet 14 having the shape of a long sheet on the supporting substrate 13.

Here, as to the coating method of the molten compound 12, a method having excellent controllability of the layer thickness, such as a slot-die method and a calendar roll method, is preferably used. Especially in order to realize high thickness accuracy, a die method or a comma coating method, both having excellent controllability of the layer thickness (namely, the method with which a layer having high thickness accuracy can be coated on the substrate surface), is preferably used. For example, in the slot-die method, the compound 12 melted to a fluid state by heating is extruded by a gear pump to put into the die thereby performing the coating. In the calendar roll method, a prescribed amount of the compound 12 is charged into a gap between two heated rolls, and the compound 12 melted by the heat of the rolls is coated onto the supporting substrate 13 with rotating the rolls. As to the supporting substrate 13, for example, a silicone-treated polyester film is used. Further, it is preferable to carry out a defoaming treatment thoroughly by using a defoaming agent, or by a heat and vacuum defoaming method, or the like, so that air bubbles may not remain in a developing layer. Further, instead of coating onto the supporting substrate 13, an embodiment may also be allowed that while being molded to a sheet shape by using an extrusion molding or an injection molding, the compound 12 melted is extruded onto the supporting substrate 13 thereby molding it to the green sheet 14 on the supporting substrate 13.

Further, in the formation process of the green sheet 14 by the slot-die method, it is preferable to measure the actual sheet thickness of the green sheet 14 after coating, thereby performing, on the basis of the measured thickness, the feedback control of a gap between the slot die 15 and the supporting substrate 13. Further, it is preferable to minimize the variation in the feed rate of the compound 12 in a fluid state supplied to the slot die 15 (for example, to suppress the variation within plus or minus 0.1%), and in addition, to also minimize the variation in the coating speed (for example, to suppress the variation within plus or minus 0.1%). As a result, thickness accuracy of the green sheet 14 can further be improved. Meanwhile, the thickness accuracy of the green sheet 14 thereby formed is within a margin of error of plus or minus 10% relative to a designed value (for example, 1 mm), preferably within plus or minus 3%, while more preferably within plus or minus 1%. Alternatively, in the calendar roll method, the film thickness of the compound 12 transferred onto the supporting substrate 13 can be controlled by controlling calendaring conditions according to an actual measurement value.

Meanwhile, a predetermined thickness of the green sheet 14 is preferably in the range of 0.05 to 20 mm. If the thickness is predetermined to be thinner than 0.05 mm, it needs to laminate many layers, which lowers the productivity.

Next, the magnetic field orientation is carried out to the green sheet 14 on the supporting substrate 13 formed by the above-mentioned hot-melt coating method. Specifically, to begin with, the green sheet 14 continuously conveyed together with the supporting substrate 13 is softened by heating. Specifically, the softening is carried out until the green sheet 14 reaches the viscosity of in the range of 1 to 1500 Pa·s, while more preferably in the range of 1 to 500 Pa·s. By so doing, the magnetic field orientation can be made properly.

Meanwhile, the appropriate temperature and duration for heating the green sheet 14 differ depending on the type or amount of the binder, but can be tentatively set, for example, at 100 to 250° C., and 0.1 to 60 minutes, respectively. However, for the purpose of softening the green sheet 14, the temperature needs to be equal to or higher than the glass transition point or the flow initiating temperature of the binder to be used. Further, the heating method for heating the green sheet 14 may be such a method as heating by a hot plate, or heating using a heating medium (silicone oil) as a heat source. Next, the magnetic field orientation is carried out by applying a magnetic field in an in-plane and machine direction of the green sheet 14 having been softened by heating. The intensity of the applied magnetic field is in the range of 5000 to 150000 [Oe], while preferably in the range of 10000 to 120000 [Oe]. As a result, the C-axis (axis of easy magnetization) of each magnet crystal contained in the green sheet 14 is aligned in one direction. Meanwhile, the application direction of the magnetic field may also be an in-plane and transverse direction of the green sheet 14. Alternatively, an embodiment that the magnetic field is simultaneously applied to plural pieces of the green sheet 14 may also be allowed.

Further, when the magnetic field is applied to the green sheet 14, an embodiment that the magnetic field is applied simultaneously with the heating may be allowed; or an embodiment that the magnetic field is applied after the heating and before the green sheet 14 solidifies may also be allowed. Alternatively, an embodiment that the magnetic field is applied before the green sheet 14 formed by the hot-melt coating solidifies may also be allowed. In such a case, the heating process is not needed.

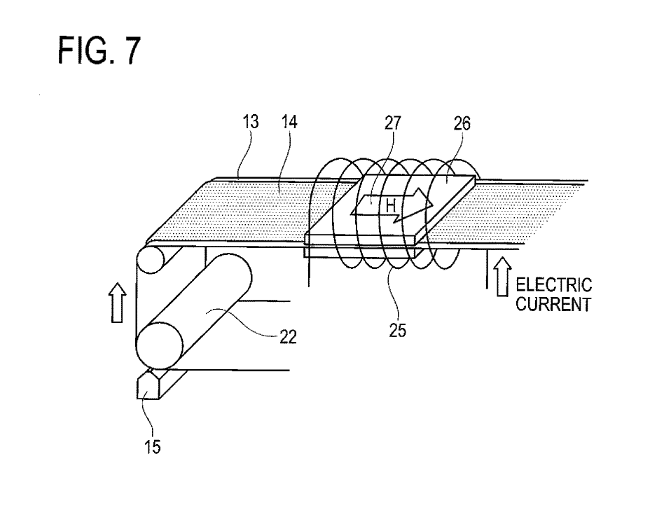

Next, the heating process and the magnetic field orientation process of the green sheet 14 will be explained in more detail with referring to FIG. 7. FIG. 7 is a schematic diagram illustrating the heating process and the magnetic field orientation process of the green sheet 14. Meanwhile, with referring to FIG. 7, an explanation will be made as to the example wherein the heating process and the magnetic field orientation process are carried out simultaneously.

As depicted in FIG. 7, the heating and the magnetic field orientation to the green sheet 14 having been coated by the above described slot-die method are carried out to the green sheet 14 having the shape of a long sheet which is in the continuously conveyed state by a roll. That is, apparatuses for the heating and the magnetic field orientation are arranged in the downstream side of a coating apparatus (such as a slot-die apparatus) so as to perform the heating and the magnetic field orientation subsequent to the coating process.

Specifically, a solenoid 25 is arranged in the downstream side of the slot die 15 and the coating roll 22 so that the green sheet 14 and the supporting substrate 13 being conveyed together may pass through the solenoid 25. Further, inside the solenoid 25, hot plates 26 are arranged as a pair on upper and lower sides of the green sheet 14. While heating the green sheet 14 by the hot plates 26 arranged as a pair on the upper and lower sides, an electric current is applied to the solenoid 25 thereby generating a magnetic field in an in-plane direction (i.e., direction parallel to a sheet surface of the green sheet 14) as well as a machine direction of the green sheet 14 having the shape of a long sheet. Thus, the green sheet 14 continuously conveyed is softened by heating, and at the same time the magnetic field is applied to the green sheet 14 thus softened in the in-plane and machine direction of the green sheet 14 (direction of the arrow 27 in FIG. 7), so that proper and uniform magnetic field orientation of the green sheet 14 can be realized. Especially, application of the magnetic field in the in-plane direction thereof can prevent surface of the green sheet 14 from bristling up.

Further, the green sheet 14 after the magnetic field orientation process is preferably cooled and solidified under the state of being conveyed, for the sake of higher efficiency in the manufacturing process.

Meanwhile, in the case that the magnetic field orientation is made in an in-plane and transverse direction of the green sheet 14, an embodiment is made such that the solenoid 25 may be replaced with a pair of magnetic coils arranged on the right and left sides of the green sheet 14 under the state of being conveyed. Through energizing both magnetic coils, a magnetic field can be generated in an in-plane and transverse direction of the green sheet 14 having the shape of a long sheet.

Further, the magnetic field orientation may also be made in a direction perpendicular to a plane of the green sheet 14. In the case that the magnetic field orientation is made in the direction perpendicular to a plane of the green sheet 14, for example, a magnetic field application apparatus using pole pieces or the like may be used. Meanwhile, in the case that the magnetic field orientation is made in the direction perpendicular to the plane of the green sheet 14, it is preferable to laminate a film on the surface opposite to the supporting substrate 13 that is laminated to the green sheet 14. By so doing, the surface of the green sheet 14 can be prevented from bristling up.

Further, instead of the heating method that uses the hot plates 26 as mentioned above, a heating method that uses a heating medium (silicone oil) as a heat source may be used as well.

Here, instead of employing the hot-melt molding method, in the case that the green sheet 14 is formed by a conventional slot-die method or a doctor blade method using a liquid material having high fluidity such as slurry, when the green sheet 14 is conveyed into the place where there is a magnetic field gradient, the magnet powder contained in the green sheet 14 is attracted to a stronger magnetic field, thereby leading to a risk of liquid localization of the slurry destined to form the green sheet 14, i.e., a risk of imbalance in the thickness of the green sheet 14. In contrast, in the case that the hot-melt molding method is employed for molding of the compound 12 to the green sheet 14 as in the present invention, the viscosity of the compound 12 reaches several tens to hundreds of thousand Pa·s at a temperature near a room temperature, so that there is no localization of the magnet powder during the time when the green sheet 14 is passing through the magnetic field gradient. Further, the viscosity of the binder therein becomes lower as the green sheet 14 is conveyed into a homogenous magnetic field and heated therein, and therefore, the uniform C-axis orientation becomes attainable merely by the rotary torque in the homogeneous magnetic field.

Further, in the case that the green sheet 14 is formed by using a liquid material having high fluidity such as an organic solvent-containing slurry by a conventional slot-die method or a doctor blade method, instead of employing the hot-melt molding method, if a sheet having the thickness of more than 1 mm is going to be formed, problematic bubbles may be formed during a drying process by evaporation of the organic solvent contained in the slurry or the like. Further, if the duration of the drying process is extended in order to suppress bubbles, the magnet powder is caused to be separated, resulting in an imbalanced density distribution of the magnet powder in the gravity direction, which in turn may cause warpage of the permanent magnet after sintering. Accordingly, in the formation from the slurry, the maximum thickness is virtually restricted; and therefore, the green sheet 14 needs to be thin with the thickness of 1 mm or less and to be laminated thereafter. However, in such a case, the binder cannot be sufficiently intermingled, which causes interlayer-delamination in the subsequent binder removal process (calcination process), leading to degradation in the orientation in the C-axis (axis of easy magnetization), namely, causing to decrease in the residual magnetic flux density (Br). In contrast, in the case that the compound 12 is molded to the green sheet 14 by using the hot-melt molding method as in the present invention, because the compound 12 does not contain an organic solvent, there is no risk of such bubbles as mentioned above, even if a sheet having the thickness of more than 1 mm is prepared. Further, because the binder is well intermingled, there is no risk of the interlayer-delamination in the binder removal process.

Further, in the case that plural pieces of the green sheet 14 are simultaneously exposed to the magnetic field, for example, an embodiment may be allowed that the plural pieces of the green sheet 14 laminated in multiple layers (for example, six layers) are continuously conveyed whereby the laminated multiple layers of the green sheet 14 are made to pass through inside the solenoid 25. By so doing, the productivity can be improved.

Next, after the green sheet 14 is subjected to the magnetic field orientation by the method as depicted in FIG. 7, the green sheet 14 is deformed by applying a load to the green sheet 14 so as to shape it to the product shape. Meanwhile, by this deformation, the direction of the axis of easy magnetization is shifted so as to become the direction of the axis of easy magnetization that is needed in the final product. By so doing, the direction of the axis of easy magnetization can be manipulated such that the axes of easy magnetization may converge to the direction along the converging axis P, as depicted in FIG. 3. Meanwhile, before the deformation, the green sheet 14 is previously punched out to the shape with taking the direction of the axis of easy magnetization needed in the shape of the final product as well as in the final product into account (namely, the shape capable of realizing the direction of the axis of easy magnetization that is needed in the final product when the shape of the final product is formed by the deformation), and then deformation thereof is carried out.

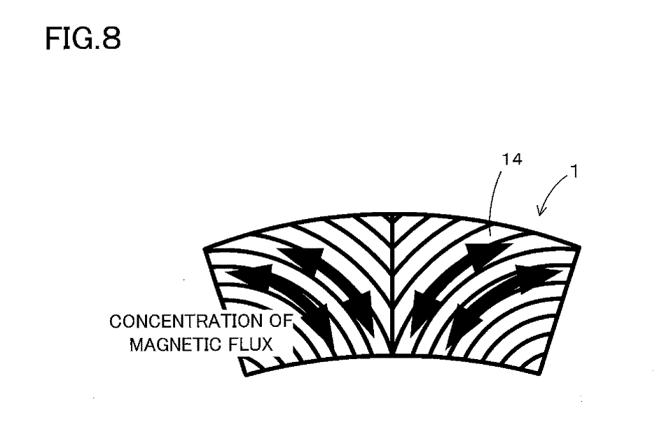

In the case that the magnet having a large size is produced, shaping may be carried out by stacking a plurality of the green sheets 14 having been deformed into the same shape followed by fixing them with each other with a resin or the like. For example, in the case that, as depicted in FIG. 3, the permanent magnet 1 in which the axes of easy magnetization (C axis) are orientated so as to converge to one direction along the converging axis P is produced, the green sheets 14 having been magnetically orientated in the in-plane direction are laminated under a curved state thereof in such a way that a cross section of the green sheet 14 in a thickness direction may be an arc-like shape, as depicted in FIG. 8. As a result, the orientation as depicted in FIG. 3 can be realized. Meanwhile, the lamination may be made after deforming the green sheet 14, or the deformation may be made after the lamination thereof.

Alternatively, the magnetic field orientation and shaping to the formed body may be carried out in the way as described below.

At first, the green sheet 14 having the sheet shape that is cut to a proper length before the magnetic field orientation is wound around a mold having a cylindrical shape. Then, to the green sheet 14 under the state of being wound to the mold, a magnetic field is applied from one direction facing to the surface of the green sheet 14. As a result, the axes of easy magnetization of each magnet particle included in the green sheet 14 are orientated in parallel along the application direction of the magnetic field. Then, while a load is applied to the green sheet 14 so as to deform to the product shape, the direction of the axis of easy magnetization is corrected by this deformation such that the axes of easy magnetization may converge to one direction along the converging axis P. For example, in the case that the segment type as depicted in FIG. 3 is formed as the product shape, while the green sheet 14 having been in a curved state along the mold is made straight, a load is applied from right and left in the lateral direction to form the shape of the segment type. As a result, with deformation of the green sheet 14, the direction of the axis of easy magnetization of the green sheet 14 is corrected, so that the orientation as depicted in FIG. 3 can be realized. Meanwhile, the green sheet 14 may be deformed only in one sheet, or may be deformed in the laminated state of plural sheets.

Also, the shape of the green sheet 14 before deformation by application of a load may be a shape other than the cylindrical shape. For example, the shape may be a fan-like shape, a bow-like shape, or a rectangular shape.

In addition, an embodiment may also be allowed in which after shaping to the formed body corresponding to the product shape, the magnetic field orientation is carried out by applying a magnetic field to the formed body. For example, one opening of a solenoid coil is disposed adjacently against the formed body, and the magnetic field that is formed by passing an electric current to the solenoid coil is applied to the formed body. Meanwhile, in a neighborhood of the solenoid coil, the magnetic field in which the lines of magnetic force diffuse in the left and right directions is formed. Accordingly, in the formed body, the axes of easy magnetization (C axes) are orientated so as to converge to one direction along the converging axis P, as depicted in FIG. 3. In addition, in place of the solenoid coil, the orientation may be made by using a permanent magnet or an electromagnet. Further, an embodiment may also be allowed in which after the mixture is molded to a ring shape, the magnetic field orientation may be carried out by applying a magnetic field to the formed body.

Next, the formed body 30 thus shaped and orientated in the magnetic field is kept at a decomposition temperature of the binder for several hours to several tens of hours (for example, five hours) in a non-oxidizing atmosphere (especially in the present invention, a hydrogen atmosphere or a mixed gas atmosphere of hydrogen and an inert gas) at a normal atmospheric pressure, or a pressure higher or lower than a normal atmospheric pressure (for example, 1.0 Pa or 1.0 MPa), thereby the calcination process is carried out. In the case that the calcination is carried out in a hydrogen atmosphere, the hydrogen feed rate during the calcination is made to, for example, 5 L/minute. By carrying out the calcination, organic compounds including the binder can be decomposed by a depolymerization reaction or the like into monomers, which can be scatteringly removed therefrom. That is, so-called decarbonization is carried out with which carbon content in the formed body 30 can be reduced. Furthermore, the calcination is carried out under such a condition that carbon content in the formed body 30 may become 2000 ppm or less, while more preferably 1000 ppm or less. By so doing, it becomes possible to densely sinter the entirety of the formed body 30 in the subsequent sintering process, so that decrease in the residual magnetic flux density or in the coercive force can be suppressed. Furthermore, in the case that the calcination is carried out under the pressure condition of higher than an atmospheric pressure, the pressure is preferably 15 MPa or lower. Meanwhile, the pressure condition of higher than an atmospheric pressure, more specifically the pressure of 0.2 Mpa or higher, especially contributes to reduction in the carbon content.

Meanwhile, the decomposition temperature of the binder is determined on the basis of the analysis results of the binder decomposition products and decomposition residues. Specifically, the temperature is selected from such a range that when the binder decomposition products are trapped, no decomposition products except monomers are formed and no products due to the side reaction of residual binder components are detected in the analysis of the residues. The temperature differs depending on the type of binder, but may be set in the range of 200 to 900° C., while more preferably in the range of 400 to 600° C. (for example, 450° C.).

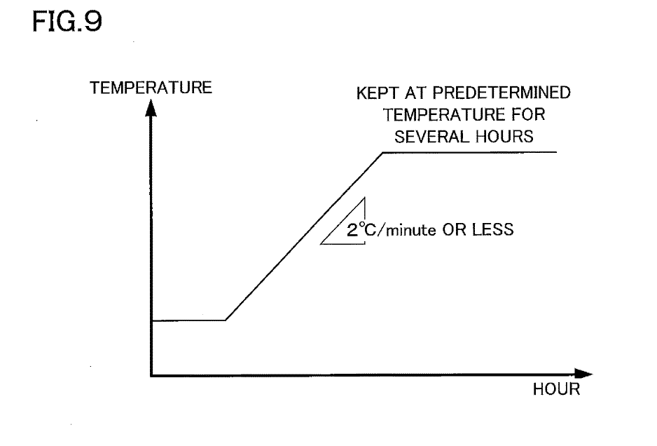

In addition, the calcination is carried out preferably at a slower temperature rising rate as compared with a general magnet sintering process. Specifically, the temperature rising rate is made 2° C./minute or less (for example, 1.5° C./minute). Therefore, in the case that the calcination is carried out, the calcination is carried out in the way as depicted in FIG. 9, that is, the temperature is raised at the prescribed temperature rising rate of 2° C./minute or less, and after the temperature reaches a predetermined set temperature (decomposition temperature of the binder), the formed body is kept at the set temperature for several hours to tens of hours. When the temperature rising rate in the calcination process is made slow as mentioned above, the carbons in the formed body 30 are not removed too rapidly but removed gradually; and thus, the density of the permanent magnet after sintering can be increased (namely, the spaces in the permanent magnet can be made less). And, when the temperature rising rate of 2° C./minute or less is selected, the density of 95% or more is attainable in the permanent magnet after sintering, so that high magnet properties can be expected.

Further thereafter, dehydrogenation may be carried out by keeping in a vacuum atmosphere the formed body 30 calcined in the calcination process. In the dehydrogenation process, NdH₃ (having high activity, formed in the calcination process) in the formed body 30 is gradually changed from NdH₃ (having high activity) to NdH₂ (having low activity), so that the activity of the formed body 30, which is activated by the calcination process, decreases. Accordingly, even if the formed body 30 calcined by the calcination process is later moved into an atmosphere, Nd therein is prevented from combining with oxygen, so that decrease in the residual magnetic flux density or in the coercive force can be suppressed. In addition, an effect may be expected that the crystal structure of the magnet be put back to the structure of Nd₂Fe₁₄B from those of NdH₂ and the like.

Next, the sintering process in which the formed body 30 having been calcined in the calcination process is subjected to sintering is carried out. Meanwhile, with regard to the sintering method of the formed body 30, there may be mentioned: a pressureless sintering under a vacuum state; a uniaxial pressure sintering in which the sintering is carried out under a state where a pressure is applied in a uniaxial direction; a biaxial pressure sintering in which the sintering is carried out under a state where a pressure is applied in a biaxial direction, and an isotropic pressure sintering in which the sintering is carried out under a state where a pressure is applied isotropically. For example, the uniaxial pressure sintering in which the formed body 30 is sintered under a state where a pressure is applied to a direction crossing to the axis of easy magnetization is used. Also, the pressure sintering includes a hot press sintering, a hot isostatic pressure (HIP) sintering, an ultrahigh pressure synthesis sintering, a gas pressure sintering, and a spark plasma (SPS) sintering. However, it is preferable to adopt the SPS sintering in which a pressure can be applied in a uniaxial direction and the sintering is carried out by an electric current sintering. Meanwhile, in the case that the sintering is carried out by the SPS sintering, preferably, the pressure value is set, for example, in the range of 0.01 to 100 MPa, and the temperature is raised to about 940° C. at the rate of 10° C./minute under a vacuum atmosphere with the pressure of not higher than several Pa, and then kept there for five minutes. The formed body is then cooled down, and again subjected to a heat treatment in the temperature range of 300 to 1000° C. for two hours. As a result of the sintering, a sintered body 31 is produced.

Then, the sintered bodies 31 wherein the shaping is made to the segment type by the afore-mentioned process and the axes of easy magnetization are orientated so as to converge to one direction along the converging axis P are adhered to the shape of an annular ring. By so doing, the sintered body having a ring shape (hereunder, this is referred to as a sintered ring body 32) is produced. Meanwhile, bonding of the sintered ring body 32 is made with an adhesive, a plasticizer, or a thermocompression bonding.

In the above example, an embodiment is employed in which after the shaped bodies 30 of the segment type are sintered, they are bonded to the shape of an annular ring to produce the sintered ring body 32; however, an embodiment may also be allowed in which after the formed body having a ring shape is produced by bonding the shaped bodies 30 before the sintering treatment so as to be the shape of an annular ring, the sintering treatment is carried out to produce the sintered ring body 32.

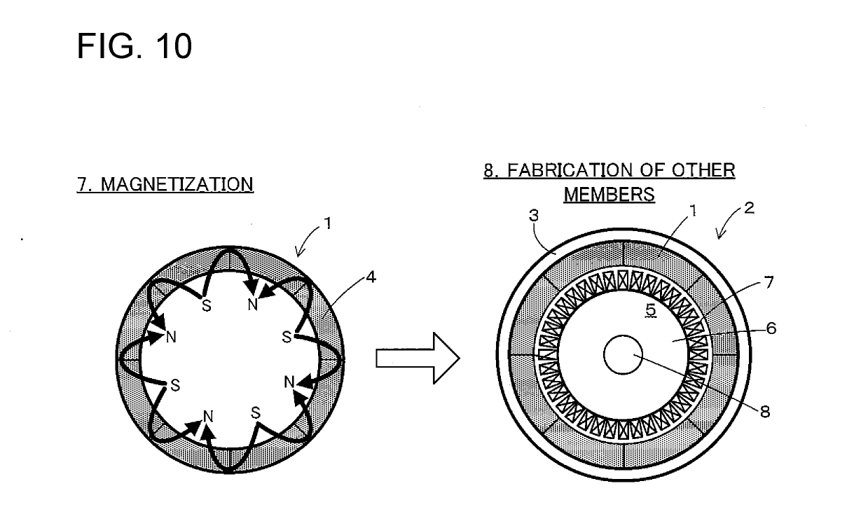

Then, as depicted in FIG. 10, magnetization is made along the C-axis so as to make an inward polar anisotropy. As a result, the permanent magnet 1 which is an anisotropic ring magnet can be produced. Meanwhile, the permanent magnet 1 is magnetized by using, for example, a magnetizing coil, a magnetizing yoke, a condenser-type magnetizing power source apparatus, or the like. Meanwhile, an embodiment may also be allowed in which magnetization of the permanent magnet 1 is made after disposing thereof to the rotor 3 of the rotating electric machine. Further, an embodiment may also allowed in which magnetization is made to the sintered body 31 before bonding to the shape of an annular ring.

Then, the permanent magnet 1 is disposed in the inner circumference surface of the rotor 3, and then, members other than the rotor 3, such as the stator 5, the rotation axis 8, and so forth are fabricated to produce the outer rotor type rotating electric machine 2. Meanwhile, in the permanent magnet 1 after magnetization, the magnetic flux inside the magnet can be concentrated to a rotation axis direction from an outside direction along a radius direction of the rotor 3 (namely, the magnetic flux density of the magnet surface can be increased).

As explained above, in the permanent magnet 1 and the manufacturing method of the permanent magnet 1 according to the present embodiment, a raw material magnet is milled to magnet powder, and the magnet powder thus milled is mixed with a binder to form the compound 12. Then, the compound 12 thus formed is molded to the green sheet 14 having the sheet shape. Thereafter, a magnetic field is applied to the green sheet 14 thus molded to carry out the magnetic field orientation; and then, with taking the direction of the magnetic field orientation of the green sheet 14 having been subjected to the magnetic field orientation into account, the green sheets 14 is shaped to the product shape by deforming thereof. Thereafter, the permanent magnet 1 is produced by sintering thereof. Also, the permanent magnet 1 has a ring shape, and the axis of easy magnetization is orientated at a slant so as to converge in a direction along the converging axis P which is set to a radius direction as well as to a center direction of the ring shape. As a result, after magnetization of the produced permanent magnet 1, the magnetic flux can be properly concentrated, so that not only the maximum magnetic flux density can be increased but also the variance in the magnetic flux density can be avoided. Especially, in the rotating electric machines, in which the rotor is disposed outside the stator, such as the outer rotor type rotating electric machine, the dual rotor type rotating electric machine, and the like, if the permanent magnet is disposed in the rotor present outside thereof, by concentrating the magnetic flux to the side of the stator present inside thereof, the maximum magnetic flux density can be increased, so that not only the torque and the electric power generation of the rotating electric machine arranged with the permanent magnet can be increased, but also the torque ripple can be reduced.

In addition, by employing an embodiment in which the mixture of the magnet powder mixed with the binder is molded, the orientation can be made such that the axes of easy magnetization properly converge to one direction along the converging axis. As a result, the magnetic flux can be properly concentrated after magnetization, so that not only the maximum magnetic flux density can be increased but also the variance in the magnetic flux density can be avoided.

In addition, because the mixture with the binder is molded, the magnet particles do not move rotationally after orientation as compared with the case of using a powder compaction molding method or the like, so that the degree of orientation can be improved as well.

In addition, in the case that the magnetic field orientation is made to the mixture with the binder, because the number of current turns can be utilized, a high magnetic field strength during the time of the magnetic field orientation process can be secured; and in addition, because a magnetic field can be applied for a long period of time in a static magnetic field, a high degree of orientation with a low variation can be realized. Further, if the orientation direction is corrected after orientation, orientation with a high orientation and a low variation can be secured.

In addition, realization of a high orientation with a low variation can contribute to reduction in the contraction variation due to sintering. That is, uniformity of the product shape after sintering can be secured. As a result, a burden of an outer shape processing after sintering can be lowered, so that a significant improvement of stability in mass production can be expected.

In addition, by approximating the wave shape of the magnetic flux density distribution along the circumferential direction of the inner circumference surface of the permanent magnet 1 to an ideal sine wave shape, the toque ripple can be reduced, and in addition, when it is disposed in the rotating electric machine, a driving control of the rotating electric machine can be carried out accurately.

In addition, in the magnetic field orientation process, with applying the magnetic field to the mixture of the magnet powder with the binder, the magnetic field orientation is carried out by manipulating the direction of the axis of easy magnetization by deforming the mixture having been applied with the magnetic field to the formed body; and thus, by deforming the mixture having been once subjected to the magnetic field orientation, the direction of the orientation can be corrected, so that the orientation can be made such that the axes of easy magnetization properly converge to one direction along the converging axis. As a result, the orientation with a high degree of orientation with a low variance can be made. In addition, while the mixture is deformed, the orientation direction can be corrected at the same time with this deformation. As a result, the shaping process of the permanent magnet and the orientation process thereof can be carried out in one process, so that the productivity can be improved.

In addition, because the magnetic field orientation is carried out after the mixture is once molded to the sheet shape, which is then followed by deformation to the formed body, the shaping process and the magnetic field orientation process can be carried out in a continuous process, so that the productivity can be improved.

In addition, because the axis of easy magnetization is slanted toward the rotation axis side along the circumferential direction of the rotor 3 of the outer rotor type rotating electric machine, in the case when the permanent magnet is disposed in the inside surface of the rotor 3 and magnetized, the magnetic flux can be concentrated more to the rotation axis direction from the outside direction of the rotor 3. As a result, a torque and an electric power generation of the rotating electric machine in which the permanent magnet 1 is disposed can be increased.

In addition, in the case when the permanent magnet is disposed in the rotor 3 of the outer rotor type rotating electric machine and magnetized, the magnetic flux inside the magnet is concentrated to the rotation axis side from the outside direction of the rotor 3, so that a torque and an electric power generation of the rotating electric machine in which the permanent magnet 1 is disposed can be increased.

In addition, in the outer rotor type rotating electric machine in which the permanent magnet 1 is disposed in the rotor 3, increase in power generation of an electric power generator, as well as increase in torque and efficiency of a motor with decrease in size and torque ripple more than ever can be realized.

Meanwhile, the present invention is not limited to the examples described above; and thus, it is a matter of course that various improvements and modifications can be made, provided that the scope thereof does not deviate from the gist of the present invention.

For example, milling conditions of the magnet powder, kneading conditions, the molding conditions, the magnetic field orientation process, calcining conditions, sintering conditions, and the like are not limited to the conditions described in the examples described above. For example, in the examples described above, a magnet raw material is milled by a wet milling using a bead mill; however, milling by a dry milling using a jet mill may also be allowed. In addition, the atmosphere in the calcination process may be other than the hydrogen atmosphere (for example, a nitrogen atmosphere, a He atmosphere, an Ar atmosphere, or the like), provided that it is a non-oxidizing atmosphere. In addition, the calcination process may be omitted. In such a case, the decarbonization is carried out in the course of the sintering process.

In addition, in the examples described above, the embodiment is employed in which the magnetic field orientation is carried out after the mixture of the magnet powder with the binder is once molded to the green formed body having a sheet shape; however, an embodiment may also be allowed in which the magnetic field orientation is carried out after molding to a shape other than the sheet shape. For example, molding may be made to the green formed body having a shape of a block. And then, the green formed body having the shape of a block which has been subjected to the magnetic field orientation is processed so as to shape to the formed body 30 having the segment-type shape.

In addition, in the examples described above, an embodiment is employed in which the magnetic field orientation is carried out to the mixture of the magnet powder with the binder followed by shaping to the formed body 30 having the segment-type shape; however, the magnetic field orientation may be carried out after shaping to the formed body 30 having the segment-type shape. The orientation direction of the magnetic field is changed in accordance with the ring magnet to be produced finally.

Further, in the examples described above, after the magnet powder is shaped to a plurality of the segment-type shapes, they are bonded to form the ring shape; however, an embodiment may also be allowed in which the magnet powder is not shaped to the segment-type shape but shaped directly to the ring shape. In this case, shaping to the ring shape may be done by, for example, punching out the green sheet 14 that having been subjected to the magnetic field orientation, or the magnetic field orientation may be carried out after the mixture is shaped to the ring shape.

In addition, in the examples described above, the orientation direction of the axis of easy magnetization of the permanent magnet is designed such that the shape of the magnetic flux density distribution along the circumferential direction of the inner circumference surface of the permanent magnet may become a sine wave shape; however, the orientation direction of the axis of easy magnetization of the permanent magnet may also be designed such that the shape thereof may become other than the sine wave shape. Meanwhile, the shape of the magnetic flux density distribution to be realized can be arbitrarily changed in accordance with the kind and use of the permanent magnet.

In addition, the permanent magnet is also applicable to the rotating electric machine in which the permanent magnet is disposed to the stator side, not to the rotor side thereof. For example, when the permanent magnet is disposed in the stator of the inner rotor type rotating electric machine, the magnetic flux inside the magnet is concentrated from the outside direction to the direction of the center where the rotor exists. Further, the permanent magnet according to the present invention is applicable to, besides a motor, various rotating electric machines such as an electric power generator, a magnetic decelerator, and the like. In the case that the rotating electric machine according to the present invention is applied to a magnetic decelerator, the stator 5 is constituted by prescribed number of magnetic pole pieces made of a magnetic material in place of the stator core 6 and the winding wire 7.

In addition, in the examples described above, the rotating electric machine having the stator 5 in which the wiring wire 7 is wound to the stator core 6 is used; however, the stator core 6 may be constituted as well by a non-magnetic body other than the magnetic body. Further, the rotating electric machine may also be a coreless motor not having a stator core. In this case, the stator 5 in which the winding wire 7 is fixed in a shape of a cup by using a resin or the like is used. In the coreless motor like this, an iron loss can be eliminated, so that the efficiency of the rotating electric machine can be enhanced.

In addition, in the examples described above, the calcination is carried out in a hydrogen atmosphere or in a mixed gas atmosphere of hydrogen and an inert gas after molding the magnet powder; however, an embodiment may also be allowed in which the calcination process is carried out for the magnet powder before molding, then the magnet powder thus calcined is molded to a formed body, and thereafter the sintering is carried out to produce the permanent magnet. When the embodiment as described above is employed, because the calcination is carried out for the magnet particle in the form of powder, the surface area of the magnet to be calcined can be made larger as compared with the case that the calcination is carried out for the magnet particle after molding. That is, the carbons in the calcined body can be reduced more surely. However, because the binder is thermally decomposed by the calcination process, the calcination process is preferably carried out after molding.

In the present invention, explanation has been given by taking the example of the Nd—Fe—B-based magnet. However, other kinds of magnet may be used as well (for example, samarium-based cobalt magnet, alnico magnet, and ferrite magnet). Further, in the alloy composition of the magnet in the present invention, the proportion of the Nd component is larger than that in the stoichiometric composition. However, also the proportion of the Nd component may be the same as that in the stoichiometric composition.

### DESCRIPTION OF REFERENCE NUMERALS AND SIGNS

1 permanent magnet
2 outer rotor type rotating electric machine
3 rotor
4 sintered member
5 stator
12 compound
14 green sheet
30 formed body
31 sintered body
32 sintered ring body

1. A permanent magnet, wherein
the permanent magnet has a ring shape, and
an axis of easy magnetization is orientated at a slant so as to converge in a direction along a converging axis which is set to a radius direction as well as to a center direction of the ring shape.

2. The permanent magnet according to claim 1, wherein a shape of a magnetic flux density distribution along a circumferential direction of an inner circumference surface becomes a sine wave shape.

3. The permanent magnet according to claim 1, wherein the permanent magnet is manufactured by a method comprising:
milling a magnet raw material into magnet powder;
preparing a mixture of the magnet powder thus milled with a binder;
carrying out a magnetic field orientation by applying a magnetic field to the mixture; and
sintering a formed body of the magnetically orientated mixture by keeping at a sintering temperature.

4. The permanent magnet according to claim 3, wherein in the magnetic field orientation process, the magnetic field orientation is carried out such that after applying a magnetic field to the mixture, a direction of an axis of easy magnetization is manipulated by deforming the mixture having been applied with the magnetic field to the formed body.

5. The permanent magnet according to claim 4, wherein in the magnetic field orientation process, after the mixture is molded to a sheet shape, a magnetic field is applied to the mixture in the sheet shape.

6. The permanent magnet according to claim 1, wherein
the permanent magnet is disposed in a rotor of an outer rotor type rotating electric machine, and
an axis of easy magnetization is orientated so as to be slanted to a rotation axis side along a circumferential direction of the rotor.

7. The permanent magnet according to claim 6, wherein in a case when the permanent magnet is disposed in the rotor of the rotating electric machine and magnetized, a magnetic flux inside the magnet is concentrated to a rotation axis direction from an outside direction of the rotor.

8. A rotating electric machine, wherein
the rotating electric machine is an outer rotor type rotating electric machine having a permanent magnet disposed in a rotor, and
the permanent magnet has a ring shape, and an axis of easy magnetization is orientated at a slant so as to converge in a direction along a converging axis which is set to a radius direction as well as to a center direction of the ring shape.

9. A method for manufacturing a permanent magnet, wherein the method is to manufacture a permanent magnet having a ring shape, and the method comprises:
milling a magnet raw material into magnet powder;
preparing a mixture of the magnet powder thus milled with a binder;
carrying out a magnetic field orientation by applying a magnetic field to the mixture; and
sintering a formed body of the magnetically orientated mixture by keeping at a sintering temperature; and
in the magnetic field orientation process, an axis of easy magnetization is orientated at a slant so as to converge in a direction along a converging axis which is set to a radius direction as well as to a center direction of the ring shape.

10. The method for manufacturing a permanent magnet according to claim 9, wherein in the magnetic field orientation process, the magnetic field orientation is carried out such that a shape of a magnetic flux density distribution along a circumferential direction of an inner circumference surface of the manufactured permanent magnet may become a sine wave shape.

11. The method for manufacturing a permanent magnet according to claim 9, wherein in the magnetic field orientation process, the magnetic field orientation is carried out such that after applying a magnetic field to the mixture, a direction of an axis of easy magnetization is manipulated by deforming the mixture having been applied with the magnetic field to the formed body.

12. The method for manufacturing a permanent magnet according to claim 11, wherein in the magnetic field orientation process, after the mixture is molded to a sheet shape, a magnetic field is applied to the mixture in the sheet shape.

13. The method for manufacturing a permanent magnet according to claim 9, wherein
the permanent magnet is disposed in a rotor of an outer rotor type rotating electric machine, and
an axis of easy magnetization is orientated so as to be slanted to a rotation axis side along a circumferential direction of the rotor.

14. The method for manufacturing a permanent magnet according to claim 13, wherein in a case when the permanent magnet is disposed in the rotor of the rotating electric machine and magnetized, a magnetic flux inside the magnet is concentrated to a rotation axis direction from an outside direction of the rotor.

15. A method for manufacturing a rotating electric machine, wherein the method is to manufacture an outer rotor type rotating electric machine which is manufactured by disposing a permanent magnet in a rotor, and
the permanent magnet has a ring shape and is manufactured by a method comprising:
milling a magnet raw material into magnet powder;
preparing a mixture of the magnet powder thus milled with a binder;
carrying out a magnetic field orientation by applying a magnetic field to the mixture; and
sintering a formed body of the magnetically orientated mixture by keeping at a sintering temperature; and
in the magnetic field orientation process, an axis of easy magnetization is orientated at a slant so as to converge in a direction along a converging axis which is set to a radius direction as well as to a center direction of the ring shape.
